(19) United States
(12) Patent Application Publication
(10) Pub. No.: US 2008/0268244 A1
(43) Pub. Date: Oct. 30, 2008

(54) Impact copolymers having improved properties

(76) Inventors: Antonios K. Doufas, Pittsburgh, PA (US); Jeffrey S. Salek, Oakdale, PA (US); Ronald A. Andrekanic, White Oak, PA (US); William C. Thurston, Pittsburgh, PA (US); Leon M. Rice, Pittsburgh, PA (US)

Correspondence Address: Matthew P. McWilliams;Drinker Biddle & Reath LLP, One Logan Square, 18th & Cherry Streets, Philadelphia, PA, 19103, US

(21) Appl. No.: 11/796,887

(22) Filed: Apr. 30, 2007

(51) Int. Cl. C08L 23/00; B32B 5/16

(52) U.S. Cl. 428/402; 264/328.17; 525/240

(57) ABSTRACT

Improvements in the aesthetic appearance and performance properties of heterophasic polymers is obtained through the breaking up and dispersion of large gels. According to the current invention, a novel process is provided for filtration of heterophasic polymers using a fiber metal felt (FMF) media. Molded articles made from impact copolymers prepared according to the present invention have improved appearance and fracture mechanics relative to impact copolymers produced according to prior art methods.

### FIELD OF THE INVENTION

The present invention relates generally to polypropylene impact copolymers. More particularly, the present invention relates to improving the properties of polypropylene impact copolymers by improving the dispersion of gels within the impact copolymers.

### BACKGROUND OF THE INVENTION

It is common industrial practice to use standard mesh screens, such as woven metal plain weave or dutch twill, to filter a polymer melt during extrusion to remove dirt and foreign matter, and in the case of some polymers to remove polymeric gels. Gels are of particular concern in the case of heterophasic polymer blends, such as polyolefin impact copolymers, since the presence of large numbers of large gels may compromise the aesthetic appearance of the copolymers and may adversely affect the performance of the copolymers. U.S. Pat. No. 5,730,885 teaches a method for reducing the number and size of polymeric gels in a polypropylene blend by filtering the blend through multiple filter screens (screen packs) during extrusion of the blend. However, standard wire screens are subject to deformation and failure at the high pressures required for polymer filtration, which limits their efficiency. U.S. Pat. No. 3,197,533 purports to address this problem through the use of a microporous sintered metal plate for reducing gels in various polymers to micron size. However, this patent teaches that minimum pressures of 5500 psi across the sintered metal plate are required. U.S. Pat. No. 4,126,560 discloses a filter media comprising sintered metal fibers for removing gels from molten polymers. The filter media is described as being for use in conjunction with a fiber spinning process wherein gels need to be removed to prevent clogging of the spinneret and/or fiber breakage. It is specifically disclosed that gels of progressively smaller sizes are trapped in the filter media, which has progressively smaller pore openings. As disclosed in “Primer on Metal Filtration Media”, E. Gregor & Associates, LLC, © 2003, such fiber metal felt media has been used in the synthetic textile industry for filtering polyester and nylon.

However, in the case of polyolefin impact copolymers complete removal of polymeric gels is undesirable since these gels contribute to the impact resistant properties of the impact copolymer.

It is therefore desirable to provide a process that improves the aesthetic appearance and performance of polyolefin impact copolymers by eliminating large polymeric gels while maintaining the presence of and improving the dispersion of smaller gels that contribute to the performance properties of polymer.

### SUMMARY OF THE INVENTION

The present invention provides a process for reducing gel size and improving gel dispersion in a polypropylene polymer. The process comprises extruding a polymer melt comprising a heterophasic blend of (a) polypropylene homopolymer or random copolymer as a continuous phase, and (b) a polypropylene copolymer rubber as a dispersed phase, and passing the polymer melt through at least one layer of a filter media comprising a fiber metal felt layer. After passing through the filter media, the polymer melt may be quenched and pelletized. Alternatively, the melt may be used directly to produce an injection molded part, or passed through a die to form a shape that may be stretched into a film or other shape, such as a bottle. The polymer melt preferably comprises a propylene-ethylene impact copolymer wherein the continuous phase comprises either a polypropylene homopolymer or random copolymer with ethylene, and the dispersed phase is a propylene-ethylene rubber.

The fiber metal felt (FMF) media useful in the process of the present invention comprises a layer of non-woven metal fibers. Preferably the fibers are a stainless steel construction, but may be fabricated from other metals.

According to one preferred embodiment of the invention, the FMF media is backed by at least one wire mesh screen, which may be of any mesh size, but is preferably in the range of 20 to 325 mesh. The wire mesh screen may be diffusion bonded to the FMF or may be separate. In another preferred embodiment, the polymer melt is passed through at least two layers of FMF media, which may be separated by one or more standard wire mesh screens.

### DETAILED DESCRIPTION OF THE INVENTION

The present invention provides polypropylene impact copolymers having improved properties as a result of reduced gel size and improved gel dispersion. The process for obtaining the improved polypropylene impact copolymers comprises passing a polymer melt of a heterophasic copolymer through a least one layer of a filter media comprising a fiber metal felt (FMF) layer so that large gels are broken up and uniformly dispersed throughout the continuous phase.

The process according to the current invention is useful to improve the aesthetic appearance and properties of any heterophasic copolymer, but is particularly useful in improving the aesthetic appearance and properties of impact copolymers comprising a blend of a polypropylene homopolymer or random copolymer as a continuous phase and a dispersed phase comprising a propylene-ethylene or other propylene-α-olefin copolymer rubber. As used herein, “blend” refers to either an in-reactor produced blend, or a physical blend of two or more separately produced polymers. Impact copolymers with a high content of rubber are particularly susceptible to the presence of gels, which comprise agglomerates of propylene-ethylene or other propylene-α-olefin copolymer rubber. The presence of gels plays a role in the impact resistant properties displayed by impact copolymers. However, the presence of large numbers of large gels can adversely affect the performance properties of the polymer, as well as the aesthetic appearance of the polymer in applications such as films and for automobiles. Polypropylene impact copolymers produced according to the current invention display improved aesthetic appearance as manifested reduced appearance of large gels, as well as improved ductile behavior as manifested by improved fracture mechanics, including enhanced shear yielding and crazing, and reduced bifurcation, relative to impact copolymers produced using traditional mesh screens.

The process according to the present invention alleviates the problem of large numbers of large gels by breaking up and dispersing large gels present in reactor powder or vis-broken impact copolymers. The process according to the current invention achieves at least a 50 percent reduction in gels larger than 550 μ. Preferably, the process of the current invention achieves a 70 to 80 percent reduction in gels larger than 550 μ. The breaking apart and dispersing of large gels is not to be equated with the retention or removal of gels, as taught in prior references. Although some level of gel retention is unavoidable in any filtering process, gel retention is preferably kept to a minimum in the practice of the present invention. As stated above, the presence of dispersed gels contributes to the impact properties of impact copolymers. Therefore, retention of significant amounts of gels on the filter media, leading to their removal from the polymer may adversely affect these properties of the polymer. In addition, such retention of gels leads to the ultimate clogging of the filter media and impairment of its effectiveness, requiring more frequent changes of the media.

The FMF media used as filter media in the process according to the present invention comprises a non-woven layer of metal fibers having a stable porosity. FMF media of this type are described in “Polymer Filtration Media Selection”, R. Geary and J. Litschert, Chemical Fibers International, 48, September 1998, pp. 328, 30, 32. FMF media of various coarseness are useful in the present invention, however, since the metal fibers are arrayed in a random non-woven pattern it is not appropriate to refer to a given media as having a single porosity, as with standard mesh screens. In fact, each layer of FMF media may have a gradient pore size design, wherein a melt passing through the media encounters a path of decreasing diameter. The preferred FMF media for use in the present invention are equivalent to standard wire mesh screens rated at porosities of from 1 to 150 microns, preferably 5 to 100 microns, more preferably 60 to 100 microns. Specific examples include FMF media rated at a nominal porosity of 60, 75, 100 and 150 microns. Nominal porosity is defined as the smallest particulate that a particular FMF media is capable of retaining. In the process according to the current invention the FMF media may be supported by a standard mesh screen. The support screen may be either diffusion bonded to the FMF media or separate. In general the mesh support screen has a low mesh size, i.e. high porosity, and is not believed to significantly improve the dispersion of gels over that obtained by the FMF media and is not necessary to the functioning of the invention, and is therefore optional. However, it is contemplated that additional standard screens of sufficiently high mesh may be used in conjunction with the FMF media to improve gels dispersion. According to an alternative embodiment of the invention, more than one layer of the FMF media may be used. Use of two or more layers of FMF media produces a further improvement in gel dispersion. In an embodiment where two or more layers of FMF media are used the layers may be separated by a mesh screen, which may in some instances contribute to the dispersion of gels, depending on the mesh of the screen. In addition, mesh support screens may also be used with the combination of two or more FMF layers.

A series of trials were run to compare the process according to the present invention to prior art methods using standard wire mesh screens. All examples were run using either a 60 or 110 melt flow rate propylene-ethylene impact copolymer powder comprising a polypropylene homopolymer continuous phase and a dispersed phase of propylene-ethylene rubber, with an additive package that included antioxidants, acid scavengers and nucleating agents. Melt flow rate (MFR) was measured using ASTM method D-1238 at 230° C. using a 2.16 kg load.

### EXAMPLE 1

### Fiber Metal Felt Media 60 Micron

A 60 MFR impact copolymer reactor powder was extruded and passed through a single layer of FMF media having a 1 inch cross section and a nominal rated porosity of 60 microns; part no. 60 AL3, available from PUROLATOR®. The powder was pelletized using a 0.75 inch single screw extruder with a maximum screw speed of 80 rpm, which was equipped with single strand die plate and a melt pump. There were four heating zones. The pressure maximum was 3000 psi. The extruder temperature conditions were set as follows: zone 1: 450° F.; zone 2: 475° F.; melt pump: 475° F.; and die plate 475° F. The screw speed was set at 68 and 40 rpm. The melt pump rpm was adjusted to control set screw speed.

### EXAMPLE 2

### Fiber Metal Felt Media 75 Micron

A 60 MFR impact copolymer reactor powder was extruded and passed through a single layer of FMF media having a 1 inch cross section and a nominal rated porosity of 75 microns; part no. 75 AL3, available from PUROLATOR®. The extruder temperature conditions, screw speed and pump speed were set as in Example 1.

### COMPARATIVE EXAMPLE 3

### Wire Mesh Screens

A 60 MFR impact copolymer reactor powder was extruded and passed through a screen pack comprising four wire mesh screens having a 1 inch cross section in a 20/40/200/40 mesh alignment. In this alignment the 200 mesh screen is responsible for the elimination of large gels. The extruder temperature conditions, screw speed and pump speed were set as in Example 1.

### EXAMPLE 4

### Dual 60 Micron Fiber Metal Felt Media

The procedure of Example 1 was repeated, except that two layers of FMF, each having a nominal rated porosity of 60 microns, were used.

### EXAMPLE 5

### Dual 60/75 Micron Fiber Metal Felt Media

Example 5 using two layers of FMF media was repeated, except that a first FMF layer having a nominal rated porosity of 60 microns was backed with a second FMF layer having a nominal rated porosity of 75 microns.

The pelletized polymer from Examples 1-5 was then used to produce films for visual evaluation and testing using a Haake mini-extruder. The films produced from Examples 1-5 were analyzed using line scanning digital camera imaging installed on the film line (Southern Analytical). The films produced from the pellets that were passed through the FMF media displayed a much smaller number of large gels, and further displayed a larger number of well dispersed small gels.

Five inch flex/DTUL (deflection temperature under load) specimens (ASTM D790, D648), were produced from the pellets from Examples 1-5 to test fracture mechanics using the double notch 4-point charpy impact test (DN-4PB) and for DN-4PB slow crack propagation experiments. These techniques are described in “Study of fracture mechanisms of multiphase polymers using the double-notch four-point bending method”, H.-J. Sue et al., J. Materials Sci., 28 (1993) 2975-2980. The DN-4PB test is an effective technique to examine the toughening mechanisms, e.g. shear yielding, crack bifurcation, crazing and path deflection, of polymers and determine the sequence of the various toughening events observed in the damage zone of the fracture.

The DN-4PB charpy impact test at room temperature yielded similar quantitative results for the FMF media and for the 200 mesh screen control as shown in Table 1. This indicates that there was no detrimental effect on charpy impact from using FMF media.

TABLE 1
DN-4PB Impact Quantitative Results.

| | | Example 3: 200 mesh |
|---|---|---|
| Example 1: 60μ FMF | Example 2: 75μ FMF | screen (control) |
| Average: 0.72 ft. lb./ | Average: 0.72 ft. lb./ | Average: 0.70 ft. lb./in² |
| in² | in² | |
| Std. Dev.: 0.04 | Std. Dev.: 0.02 | Std. Dev.: 0.03 |
| RSD %: 5.2 | RSD %: 2.3 | RSD %: 4.3 |

The samples produced using the FMF media in Examples 1 and 2 were differentiated from the control produced using a 200 mesh screen in Example 3 when observed using optical microscopy under cross polar light mode. The fracture mechanics of the samples, determined by the DN-4PB slow crack propagation experiments show that the samples produced in Example 3 exhibited more bifurcation relative to Examples 1 and 2. Further, Examples 1 and 2 displayed a greater degree of crazing, which is preferred. The greater degree of bifurcation in the samples produced using the 200 mesh screen is thought to be due to the presence of higher amounts of large gels than in the samples produced using the FMF media.

In addition, despite the low rated porosity of the FMF media, the system pressures experienced during extrusion and filtration steps were well within the 3000 psi maximum limit. The 75 AL3 FMF media displayed a die pressure plateau at about 1000 psi. The 60 AL3 FMF media displayed a die pressure plateau at about 1750 psi. This indicates that screen bulging and catastrophic screen failure associated with excessive pressure is less of a concern with FMF media.

Gel count results for Examples 1-5 are displayed in Table 2. The results in Table 2 demonstrate that the use of the FMF material substantially reduced the number of large gels relative to the standard 200 mesh wire screen. Notably the gel count for gels averaging 550μ and higher for the samples produced using the 60 and 75 micron FMF media is significantly lower than for the standard 200 mesh screen. In addition, the total number of gels averaging 250μ and higher is substantially lower in both samples produced using the FMF media. The use of two layers of FMF media resulted in a reduction in gels averaging 550μ and larger and averaging 250μ and larger which is substantially greater than 200 mesh screen. Gels averaging 800μ and larger were almost completely eliminated.

TABLE 2
Gel Count

| | 100μ | 200μ | 300μ | 400μ | 500μ | 600μ | 700μ | 800μ | 900μ | >900μ | >550μ | >250μ | |
|---|---|---|---|---|---|---|---|---|---|---|---|---|---|
| Ex. | ave. | ave. | ave. | ave. | ave. | ave. | ave. | ave. | ave. | ave. | ave. | ave. | Total |
| 1 | 192472 | 115770 | 27773 | 5168 | 1148 | 306 | 101 | 37 | 13 | 8 | 465 | 34554 | 342797 |
| 2 | 214928 | 146022 | 41804 | 8692 | 1987 | 494 | 123 | 45 | 11 | 10 | 683 | 53166 | 414118 |
| 3 | 195767 | 151943 | 66248 | 23391 | 7990 | 2477 | 682 | 194 | 53 | 26 | 3432 | 101061 | 448771 |
| 4 | 140467 | 68119 | 11937 | 1875 | 454 | 138 | 32 | 4 | 1 | 0 | 175 | 14441 | 223029 |
| 5 | 166048 | 85736 | 14993 | 1893 | 304 | 65 | 12 | 4 | 1 | 1 | 83 | 17273 | 269057 |

Table 3 presents the same results as a percentage of total gels for Examples 1 through 5, using the 60 MFR polymer. The single FMF layer samples, 1 and 2 show only about 0.14 and 0.17 percent respectively of gels having an average size of greater than 550μ, as compared to approximately 0.76 percent for the sample produced using the 200 mesh screen in Example 3. There is also a significant difference for gels having an average size of 250μ or more. Samples 4 and 5, produced using two FMF layers show less than 0.1 percent of gels having an average size of greater than 550μ.

TABLE 3
Gel Fraction

| | 100μ | 200μ | 300μ | 400μ | 500μ | 600μ | 700μ | 800μ | 900μ | >900μ | >550μ | >250μ | |
|---|---|---|---|---|---|---|---|---|---|---|---|---|---|
| Ex. | ave. | ave. | ave. | ave. | ave. | ave. | ave. | ave. | ave. | ave. | ave. | ave. | Total |
| 1 | 56.15 | 33.77 | 8.10 | 1.51 | 0.33 | 0.09 | 0.03 | 0.01 | 0.003 | 0.002 | 0.14 | 10.08 | 100.0 |
| 2 | 51.90 | 35.26 | 10.09 | 2.10 | 0.48 | 0.12 | 0.03 | 0.01 | 0.003 | 0.002 | 0.17 | 12.84 | 100.0 |
| 3 | 43.62 | 33.86 | 14.76 | 5.21 | 1.78 | 0.55 | 0.15 | 0.04 | 0.01 | 0.006 | 0.76 | 22.51 | 99.99 |
| 4 | 62.98 | 30.54 | 5.35 | 0.84 | 0.20 | 0.06 | 0.01 | 0.002 | 0.0005 | 0 | 0.07 | 6.46 | 100.0 |
| 5 | 61.71 | 31.87 | 5.57 | 0.70 | 0.11 | 0.02 | 0.004 | 0.001 | 0.0004 | 0.0004 | 0.03 | 6.41 | 100.0 |

### EXAMPLE 6

### FMF Media 75 Micron

A pelletized impact copolymer was produced on a manufacturing scale extruder by passing a polymer melt of a 110 MFR reactor impact copolymer powder through a single layer of FMF media having a rated porosity of 75 microns.

### COMPARATIVE EXAMPLE 7

### Wire Mesh Screen

A comparative example was run on the same production scale extruder equipment, using the same reactor impact copolymer powder as in Example 6 to produce a pelletized polymer. The screen pack used in the comparative trial had a 20/40/200/40 configuration.

Films using pellets from Examples 6 and 7 were produced for visual evaluation using a Haake mini-extruder. The films produced from Examples 6 and 7 were analyzed using line scanning digital camera imaging installed on the film line (Southern Analytical).

Tables 4 and 5 show the gel count and percentage data for Examples 6 and 7. In Examples 6 and 7 using the 110 MFR polymer, only about 0.5 percent of the gels in the sample produced using the 75μ FMF media have an average size of greater than 550μ, compared with about 2.3 percent of the gels in the sample produced using the standard 200 mesh screen. In addition, the data show that less than 11 percent of the gels in the sample produced using the FMF media average 250μ or higher, as compared to over 19 percent for the samples produced using the standard mesh screen.

TABLE 4
Gel Count

| | 100μ | 200μ | 300μ | 400μ | 500μ | 600μ | 700μ | 800μ | 900μ | >900μ | >550μ | >250μ | |
|---|---|---|---|---|---|---|---|---|---|---|---|---|---|
| Ex. | ave. | ave. | ave. | ave. | ave. | ave. | ave. | ave. | ave. | ave. | ave. | ave. | Total |
| 6 | 286144 | 142146 | 36003 | 9957 | 3249 | 1254 | 564 | 296 | 183 | 195 | 2492 | 51701 | 479991 |
| 7 | 228149 | 125108 | 44330 | 19516 | 9779 | 5305 | 2666 | 1248 | 494 | 341 | 10054 | 83679 | 436936 |

TABLE 5
Gel Fraction

| | 100μ | 200μ | 300μ | 400μ | 500μ | 600μ | 700μ | 800μ | 900μ | >900μ | >550μ | >250μ | |
|---|---|---|---|---|---|---|---|---|---|---|---|---|---|
| Ex. | ave. | ave. | ave. | ave. | ave. | ave. | ave. | ave. | ave. | ave. | ave. | ave. | Total |
| 6 | 59.61 | 29.61 | 7.5 | 2.07 | 0.68 | 0.26 | 0.12 | 0.06 | 0.04 | 0.04 | 0.52 | 10.77 | 99.99 |
| 7 | 52.22 | 28.63 | 10.15 | 4.47 | 2.24 | 1.21 | 0.61 | 0.29 | 0.11 | 0.08 | 2.3 | 19.16 | 100.01 |

The invention has thus been explained with reference to specific examples. However, the invention applies to a wide range of impact copolymers from fractional (<1 g/10 min.) melt flow rates to 1500 g/10 min. The invention may be particularly useful with impact copolymers having melt flow rates ranging from 50 to 150 g/10 min. The process may be used to reduce large gels and improve dispersion of gels in reactor powder, as well as previously pelletized materials. It is also contemplated that the reactor powder or pelletized material may be compounded with one or more of several modifiers including, but not limited to elastomers, rubber modifiers and oils. Further, the process is not limited to a single iteration of the filtration. In particular, a reactor powder may be filtered through an FMF filter media according to the current invention and pelletized. The pelletized polymer may then be subjected to a second melt extrusion step, wherein it is compounded with one or more of several modifiers including, but not limited to elastomers, rubber modifiers and oils. It is contemplated that the compounded polymer melt may also be subjected to a second filtration through an FMF media to reduce the occurrence of large gels and improve gel dispersion. The invention also applies to impact copolymers containing a wide variety of additives including, but not limited to, antioxidants, antistatics, nucleators and slip agents.

What is claimed is:

1. A process for improving gel size and distribution in a polypropylene polymer comprising:
extruding a polymer melt comprising a heterophasic blend of polypropylene homopolymer or random copolymer, and a polypropylene copolymer rubber; and
passing the polymer melt through at least one layer of a filter media comprising a fiber metal felt layer.

2. The process according to claim 1, further comprising quenching and pelletizing the polymer melt.

3. The process according to claim 1, further comprising injection molding the polymer melt to produce a molded article.

4. The process according to claim 1, further comprising passing the polymer melt through a die to form an extruded shape; and stretching the extruded shape to form an article.

5. The process according to claim 1, wherein the at least one layer of filter media further comprises a mesh screen.

6. The process according to claim 1, wherein the polymer melt is passed through at least two layers of filter media, each layer comprising a fiber metal felt.

7. The process according to claim 1, further comprising, compounding the polymer melt with at least one component selected from the group consisting of elastomers, modifiers and oils prior to passing through the at least one layer of filter media.

8. The process according to claim 7, further comprising quenching and pelletizing the polymer melt.

9. The process according to claim 7, further comprising injection molding the polymer melt to produce a molded article.

10. The process according to claim 7, further comprising passing the polymer melt through a die to form an extruded shape; and stretching the extruded shape to form an article.

11. The process according to claim 1, wherein the polymer melt comprises a blend of a propylene homopolymer and a propylene-ethylene copolymer rubber.

12. The process according to claim 1, wherein the polymer melt comprises a blend of a propylene-ethylene random copolymer and a propylene-ethylene copolymer rubber.

13. A pelletized polypropylene polymer produced according to the process of claim 1, wherein about 12 percent or less of polymeric gels in the pelletized polypropylene polymer have an average size of 250 microns or more.

14. A pelletized polypropylene polymer according to claim 13, wherein about 0.5 percent or less of polymeric gels in the pelletized polypropylene polymer have an average size of 550 microns or more.

15. The process according to claim 1, wherein the number of gels having a size of greater than 550 microns is reduced by at least 50 percent.

16. The process according to claim 1, wherein the polymer melt is produced by melt extruding a pelletized polymer.

17. The process according to claim 7, wherein the polymer melt is produced by melt extruding a pelletized polymer.
